(19) United States
(12) Patent Application Publication
(10) Pub. No.: US 2021/0158738 A1
(43) Pub. Date: May 27, 2021

(54) SENSING CIRCUIT AND SOURCE DRIVER INCLUDING THE SAME

(71) Applicant: Silicon Works Co., Ltd., Daejeon (KR)

(72) Inventors: Dong Ju Kim, Daejeon (KR); Ji Su Son, Daejeon (KR); Won Kim, Daejeon (KR)

(73) Assignee: Silicon Works Co., Ltd., Daejeon (KR)

(21) Appl. No.: 16/953,719

(22) Filed: Nov. 20, 2020

(30) Foreign Application Priority Data
Nov. 22, 2019 (KR) 10-2019-0151402
Oct. 28, 2020 (KR) 10-2020-0141013

(51) Int. Cl. G09G 3/20

(52) U.S. Cl. CPC G09G 3/20; G09G 2370/045; G09G 2310/0294

(57) ABSTRACT

Provided area sensing circuit capable of accurately sensing characteristics of pixels and a source driver including the same. The sensing circuit may include multiple channels configured to receive a plurality of input signals from a display panel and a sampling circuit configured to sample the plurality of input signals received through the multiple channels and scale a plurality of sampling signals. The sampling circuit may sample the plurality of input signals at the same first time, and may scale the plurality of sampling signals at the same second time.

### BACKGROUND

### 1. Technical Field

The present disclosure relates to a display device, and more particularly, to a sensing circuit capable of accurately sensing characteristics of pixels and a source driver including the same.

### 2. Related Art

In general, a display device includes a display panel, a display driving device, a timing controller, etc.

The display driving device may include source drivers integrated in a chip form, and may include a plurality of source drivers by considering the size and resolution of the display panel. The source driver converts digital video data, provided by the timing controller, into a source signal and provides the source signal to the display panel.

Furthermore, the source drivers sense pixel signals of the display panel and convert the pixel signals into digital data. In this case, the source drivers according to a conventional technology sequentially sample input signals from multiple channels according to the speed of an ADC.

However, the conventional technology has a problem in that sensing accuracy is low when a time-dependent mobility characteristic is sensed because there is a difference between times when input signals from multiple channels are sampled. Furthermore, the conventional technology has a problem in that sensing accuracy is further low because a difference between times when input signals from multiple channels are sampled is further increased as the number of multiple channels is increased.

### SUMMARY

Various embodiments are directed to providing a sensing circuit capable of accurately sensing characteristics of pixels and a source driver including the same.

Furthermore, various embodiments are directed to providing a sensing circuit for simultaneously sampling a plurality of high-voltage input signals and simultaneously scaling the plurality of high-voltage input signals into low voltages and a source driver including the same.

In an embodiment, a sensing circuit may include multiple channels configured to sense mobility characteristics of pixels of a display panel, first switches configured to transmit input signals from the multiple channels at a first time, and sample and hold circuits configured to sample and hold the input signals received through the first switches.

In an embodiment, a source driver may include multiple channels configured to sense mobility characteristics of pixels of a display panel, a sensing circuit configured to sense input signals from the multiple channels, and an analog-to-digital converter (ADC) configured to convert sampling signals of the sensing circuit into digital data. The sensing circuit may include first switches configured to transmit the input signals of the multiple channels at a first time and sample and hold circuits configured to sample and hold the input signals received through the first switches.

In an embodiment, a source driver may include multiple channels configured to sense mobility characteristics of pixels of a display panel, a sensing circuit configured to sample and hold the input signals from the multiple channels, an analog-to-digital converter (ADC) configured to convert sampling signals of the sensing circuit into digital data, and a control circuit configured to control the sensing circuit to apply a reference voltage to the multiple channels in an initialization period, to apply program data to the pixels of the display panel in a sampling period, and to sense the input signals at a first time. The first time may be set as a time after a lapse of a given time since the program data is applied to the pixels.

In an embodiment, a sensing circuit may include multiple channels configured to receive a plurality of input signals from a display panel and a sampling circuit configured to sample the plurality of input signals received through the multiple channels and scale a plurality of sampling signals. The sampling circuit may sample the plurality of input signals at a same first time, and may scale the plurality of sampling signals at a same second time.

In an embodiment, a source driver may include a sensing circuit including multiple channels configured to receive a plurality of input signals from a display panel and a sampling circuit configured to sample the plurality of input signals received through the multiple channels and to scale the plurality of sampling signals, and an analog-to-digital converter (ADC) configured to convert output signals of the sensing circuit into digital data. The sensing circuit may sample the plurality of input signals at a same first time and may scale the plurality of sampling signals at a same second time.

### BRIEF DESCRIPTION OF THE DRAWINGS

FIG. 1 is a block diagram of a source driver including a sensing circuit according to an embodiment.

FIG. 2 is a timing diagram of the sensing circuit according to an embodiment.

FIG. 3 is a block diagram of a source driver that processes simultaneous inputs according to an embodiment.

FIG. 4 is a timing diagram of the source driver of FIG. 3 that processes simultaneous inputs.

FIG. 5 is a block diagram of a sensing circuit and a source driver including the same according to another embodiment.

FIG. 6 is a timing diagram of the sensing circuit according to another embodiment.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

Embodiments provide a sensing circuit capable of accurately sensing mobility characteristics of pixels and a display driving device including the same.

In embodiments, multiple channels may be defined as signal lines coupled to the data lines or sensing lines of a display panel in order to sense the pixel signals of the display panel.

In embodiments, an initialization period may be defined as a period in which values of the pixels of a display panel are initialized by applying a reference voltage to the pixels.

In embodiments, a sampling period may be defined as a period in which program data is applied to the pixels of a display panel and values of input signals IN<1> to IN<N> are sampled and held through multiple channels. In this case, N is a natural number equal to or greater than 2.

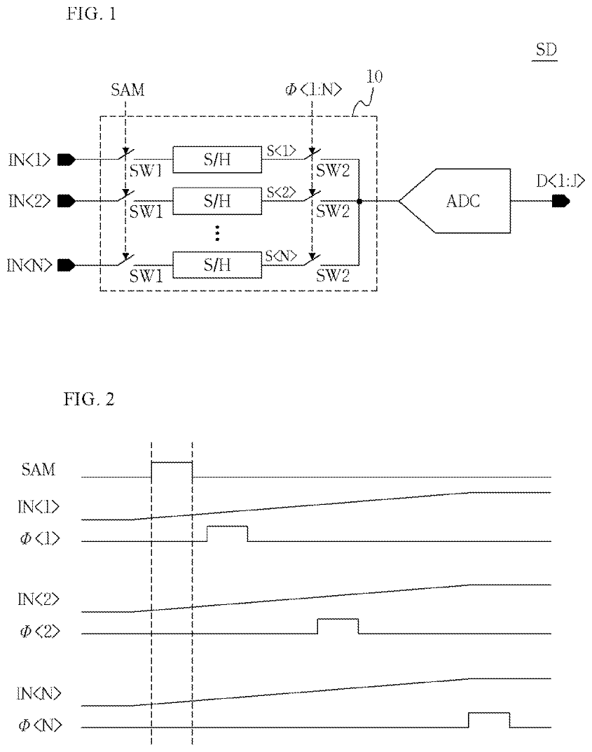

FIG. 1 is a block diagram of a source driver SD including a sensing circuit 10 according to an embodiment.

Referring to FIG. 1, the source driver SD may include the sensing circuit 10 and an analog-to-digital converter (ADC).

The sensing circuit 10 senses values of input signals IN<1> to IN<N> from multiple channels. The values of the input signals IN<1> to IN<N> may be used to calculate mobility characteristics of pixels.

Detailed elements of the sensing circuit 10 are described below. The sensing circuit 10 may include first switches SW1, sample and hold circuits S/H, and second switches SW2.

The first switches SW1 are coupled to the multiple channels, respectively. The first switches SW1 transmit the input signals IN<1> to IN<N> of the multiple channels to the sample and hold circuits S/H.

In this case, the first switches SW1 transmit the input signals IN<1> to IN<N> of the multiple channels to the sample and hold circuits S/H in response to first control signals SAM enabled at the same time. For example, the first control signals SAM may be enabled at a first time set as a time after a lapse of a given time since program data is applied to the pixels of a display panel.

That is, the first switches SW1 may be simultaneously turned on at the first time set as a time after a lapse of the given time since the program data is applied to the pixels of the display panel, and may transmit the input signals IN<1> to IN<N> from the multiple channels to the sample and hold circuits S/H.

The sample and hold circuits S/H are coupled to the first switches SW1, respectively. The sample and hold circuits S/H simultaneously sample and hold the input signals IN<1> to IN<N> received from the first switches SW1 at the same time.

The second switches SW2 are coupled to the sample and hold circuits S/H, respectively. The second switches SW2 transmit sampling signals S<1> to S<N> of the sample and hold circuits S/H to the ADC.

In this case, the second switches SW2 transmit the sampling signals S<1> to S<N> to the ADC in response to second control signals Φ<1:N> enabled at given time intervals. In this case, the given time interval may be set as a time for which the ADC can convert one sampling signal into digital signals D<1:J>.

That is, the second switches SW2 may be sequentially turned on to sequentially transmit the sampling signals S<1> to S<N> to the ADC.

The source driver SD may further include a control circuit (not illustrated).

The control circuit may initialize the pixels of the display panel in the initialization period. For example, the control circuit may initialize values of the pixels of the display panel by applying a reference voltage VREF (illustrated in FIG. 3) to the pixels through the multiple channels.

Furthermore, the control circuit may apply program data to the pixels of the display panel in the sampling period. Furthermore, after applying the program data in the sampling period, the control circuit may simultaneously turn on the first switches SW1 after a lapse of a given time. In this case, the given time may be set as a time for which values of the input signals IN<1> to IN<N> from the multiple channels rise due to the program data and the sample and hold circuits S/H can sample the risen values.

That is, the control circuit may simultaneously turn on the first switches SW1 so that the sample and hold circuits S/H sample and hold values of the input signals IN<1> to IN<N> at the same time.

The ADC is coupled to the outputs of the sample and hold circuits S/H. The ADC sequentially converts, into the digital data D<1:J>, the sampling signals S<1> to S<N> of the sensing circuit 10 that are sequentially received. In this case, J is a natural number.

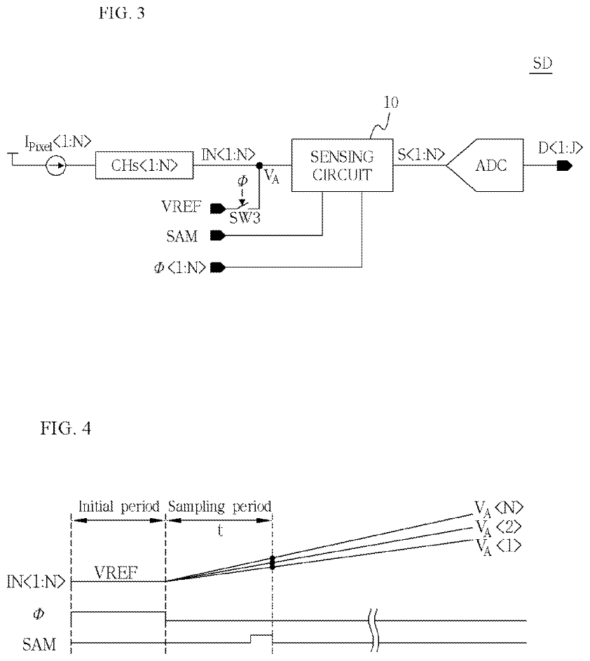

FIG. 2 is a timing diagram of the sensing circuit 10 according to an embodiment.

Referring to FIGS. 1 and 2, the first switches SW1 coupled to the multiple channels are simultaneously turned on in response to the first control signals SAM enabled at the same time, and simultaneously transmit the input signals IN<1> to IN<N> of the multiple channels to the sample and hold circuits S/H.

Furthermore, the second switches SW2 coupled to the sample and hold circuits S/H are sequentially turned on in response to the second control signals Φ<1> to Φ<N> that are sequentially enabled, and sequentially transmit the sampling signals S<1> to S<N> to the ADC.

FIG. 3 is a block diagram of the source driver SD that processes simultaneous inputs according to an embodiment.

Referring to FIG. 3, the source driver SD may include multiple channels CHs<1:N>, the sensing circuit 10, and the ADC.

The multiple channels CHs<1:N> may be coupled to data lines or sensing lines of a display panel depending on the type of pixels. In this document, a description on the type of pixel is omitted. The multiple channels CHs<1:N> provide signals I_{Pixel}<1:N> of pixels to the sensing circuit 10 as the input signals IN<1:N>.

The sensing circuit 10 senses values of the input signals IN<1:N> of the multiple channels CHs<1:N>. The values of the input signals IN<1:N> may be used to calculate mobility characteristics of the pixels. A detailed description on the sensing circuit 10 is substituted with the description of FIG. 1.

The ADC is coupled to the output of the sensing circuit 10. The ADC converts the sampling signals S<1:N> of the sensing circuit 10 into the digital data D<1:J>.

Furthermore, the source driver SD may initialize the pixels of the display panel in the initialization period. For example, the source driver SD may initialize values of the pixels of the display panel by applying the reference voltage VREF to the pixels through the multiple channels CHs<1:N>.

The source driver SD may include a switch SW3 for transmitting the reference voltage VREF to the multiple channels CHs<1:N>. In this case, the source driver SD may enable a third control signal Φ in the initialization period.

Furthermore, the source driver SD may apply program data to the pixels of the display panel in the sampling period. For example, the source driver SD may apply the program data to the pixels through the data line.

Furthermore, after applying the program data, the source driver SD may control the sensing circuit 10 to sample and hold values VA of the input signals IN<1:N> of the multiple channels CHs<1:N> at the same time.

For example, the source driver SD provides the sensing circuit 10 with the first control signals SAM enabled at the same time. Then, the sensing circuit 10 may simultaneously sample and hold the values VA of the input signals IN<1:N> of the multiple channels CHs<1:N> in response to the first control signals SAM.

Furthermore, the source driver SD may control the sensing circuit 10 to sequentially transmit the sampling signals S<1:N> to the ADC.

For example, the source driver SD provides the sensing circuit 10 with the second control signals Φ<1:N> that are sequentially enabled. Then, the sensing circuit 10 may sequentially transmit the sampling signals S<1:N> to the ADC in response to the second control signals Φ<1:N>.

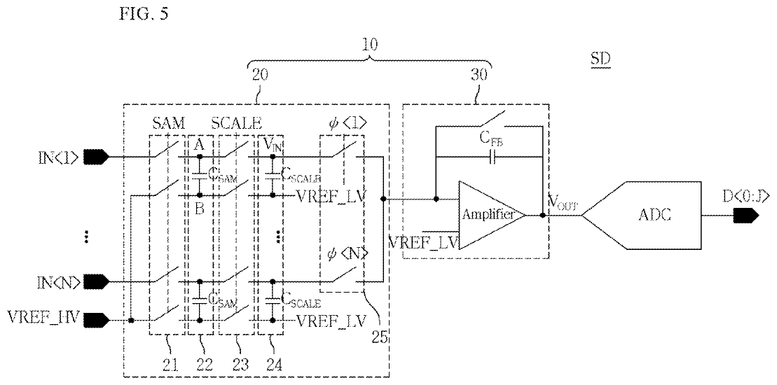

FIG. 4 is a timing diagram of the source driver of FIG. 3 that processes simultaneous inputs.

Referring to FIGS. 3 and 4, in the initialization period, the reference voltage VREF is applied to the multiple channels CHs<1:N>, so the values VA of the input signals IN<1:N> become levels of the reference voltage VREF.

Next, in the sampling period, program data is applied to the pixels of the display panel, so the values VA of the input signals IN<1:N> gradually rise. At this time, the sensing circuit 10 of the source driver SD samples and holds the input signals IN<1:N> of the multiple channels CHs<1:N> at the same time.

Equation 1 below is an equation for computing the values VA of the input signals IN<1:N> of the multiple channels CHs<1:N>.

$${V}_{A} \text{<} N \text{>} = Vref + \frac{{I}_{Pixel} \text{<} N \text{>} \cdot t}{{C}_{Load}} \\ {V}_{A} \text{<} 2 \text{>} = Vref + \frac{{I}_{Pixel} \text{<} 2 \text{>} \cdot t}{{C}_{Load}} \\ {V}_{A} \text{<} 1 \text{>} = Vref + \frac{{I}_{Pixel} \text{<} 1 \text{>} \cdot t}{{C}_{Load}} \qquad ( 1 )$$

As shown in Equation 1, the values VA of the input signals IN<1:N> may be calculated by applying the same equation thereto because the values VA are sampled at the same time. If the input signals IN<1:N> of the multiple channels CHs<1:N> are sampled at different times, an equation for calculating the values VA of the input signals IN<1:N> may become complicated due to a difference between sampling times.

The present embodiments can simplify an equation for calculating the values VA of the input signals IN<1:N> because the input signals IN<1:N> of the multiple channels CHs<1:N> are sampled at the same time. The values VA of the input signals IN<1:N> may be used to calculate a current of pixels, and may be used to calculate mobility characteristics of the pixels through the current of the pixels.

Furthermore, the source driver SD may convert the sampling signals S<1:N> of the sensing circuit 10 into the digital data D<1:J>, and may provide the digital data D<1:J> to a timing controller (not illustrated).

The timing controller (not illustrated) may calculate a mobility characteristic of each of the pixels based on the digital data D<1:J>, and may compensate for digital video data by generating compensation data into which the mobility characteristics of the pixels have been incorporated.

As described above, embodiments can accurately sense mobility characteristics of pixels because the input signals IN<1:N> of the multiple channels CHs<1:N> are simultaneously sampled.

Furthermore, embodiments can accurately sense mobility characteristics of pixels regardless of an increase in the number of multiple channels CHs<1:N>.

Furthermore, embodiments may enable picture quality to be compensated for by accurately sensing mobility characteristics of pixels.

FIG. 5 is a block diagram of a sensing circuit and a source driver including the same according to another embodiment.

Referring to FIG. 5, a source driver SD may include a sensing circuit 10 and an ADC.

The sensing circuit 10 may include multiple channels for receiving a plurality of input signals IN<1> to IN<N> from a display panel, a sampling circuit 20 for sampling the plurality of input signals IN<1> to IN<N> and scaling a plurality of sampling signals, and an amplifier circuit 30 for amplifying scaling signals and outputting an output signal Vₒᵤₜ to the ADC.

The sampling circuit 20 may sample the plurality of input signals IN<1> to IN<N> at the same first time, and may scale the plurality of sampling signals at the same second time.

The sampling circuit 20 may scale the plurality of sampling signals into lower voltages than the plurality of sampling signals.

The sampling circuit 20 may sequentially output, to the amplifier circuit 30, scaling signals corresponding to the multiple channels, respectively.

The sampling circuit 20 may include a first switch circuit 21, a first capacitor circuit 22, a second switch circuit 23, a second capacitor circuit 24, and a third switch circuit 25.

The first switch circuit 21 may transmit, to the first capacitor circuit 22, the plurality of input signals IN<1> to IN<N> received through the multiple channels and a first reference voltage VREF_HV received through a first reference voltage terminal.

For example, the first switch circuit 21 may include switches for transmitting the plurality of input signals IN<1> to IN<N> to the first capacitor circuit 22 and switches for transmitting the first reference voltage VREF_HV to the first capacitor circuit 22.

The first switch circuit 21 may transmit the plurality of input signals IN<1> to IN<N> and the first reference voltage VREF_HV to the first capacitor circuit 22 at the same first time in response to sampling signals SAM.

The first capacitor circuit 22 may sample a difference between the plurality of input signals IN<1> to IN<N> and the first reference voltage VREF_HV.

For example, the first capacitor circuit 22 may include sampling capacitors C_{SAM} each having one end to which each of the plurality of input signals IN<1> to IN<N> is applied and the other end to which the first reference voltage VREF_HV is applied.

The first capacitor circuit 22 may include the sampling capacitors C_{SAM} corresponding to the multiple channels, respectively.

The second switch circuit 23 may transmit, to the second capacitor circuit 24, a plurality of sampling signals sampled by the first capacitor circuit 22 and a second reference voltage VREF_LV received through second reference voltage terminals.

For example, the second switch circuit 23 may include switches for transmitting the plurality of sampling signals of the first capacitor circuit 22 to the second capacitor circuit 24 and switches for transmitting the second reference voltage VREF_LV to the second capacitor circuit 24.

The second switch circuit 23 may transmit the plurality of sampling signals and the second reference voltage VREF_LV to the second capacitor circuit 24 at the same second time in response to scaling signals SCALE.

The second capacitor circuit 24 may sample a difference between the plurality of sampling signals and the second reference voltage VREF_LV.

For example, the second capacitor circuit 24 may include scaling capacitors C_{SCALE} each having one end to which each of the plurality of sampling signals is applied and the other end to which the second reference voltage VREF_LV is applied.

The second capacitor circuit 24 may include the scaling capacitors C_{SCALE} corresponding to the multiple channels, respectively.

In this case, the second reference voltage VREF_LV may be set to be lower than the first reference voltage VREF_HV.

The second capacitor circuit 24 may shift levels of sampling signals, sampled by the first capacitor circuit 22 and having a high-voltage range, into levels of scaling signals having a low-voltage using the second reference voltage VREF_LV set to be lower than the first reference voltage VREF_HV.

In this case, the second reference voltage VREF_LV may vary depending on an input voltage range of the ADC.

In this case, the voltage range of the scaling signals may be changed by adjusting the capacities of the sampling capacitor C_{SAM} and the scaling capacitor C_{SCALE}.

The third switch circuit 25 may sequentially transmit, to the amplifier circuit 30, the plurality of scaling signals sampled by the second capacitor circuit 24.

For example, the third switch circuit 25 may include switches turned on in response to control signals Φ<1> to Φ<N> enabled at given time intervals, and may sequentially transmit the plurality of scaling signals to the amplifier circuit 30 through the switches that are sequentially turned on.

The amplifier circuit 30 may amplify the plurality of scaling signals sequentially received from the sampling circuit 20, and may output the output signal V_{OUT} to the ADC.

For example, the amplifier circuit 30 may include an amplifier, a feedback capacitor C_{FB}, and a reset switch. An amplification ratio of the amplifier may vary depending on the capacities of the scaling capacitor C_{SCALE} and the feedback capacitor C_{FB}.

The ADC may convert the output signal V_{OUT} into digital data D<0:J>, and may provide the digital data D<0:J> to the timing controller. The timing controller may incorporate characteristics of pixels of a display panel into video data using the digital data D<0:J>.

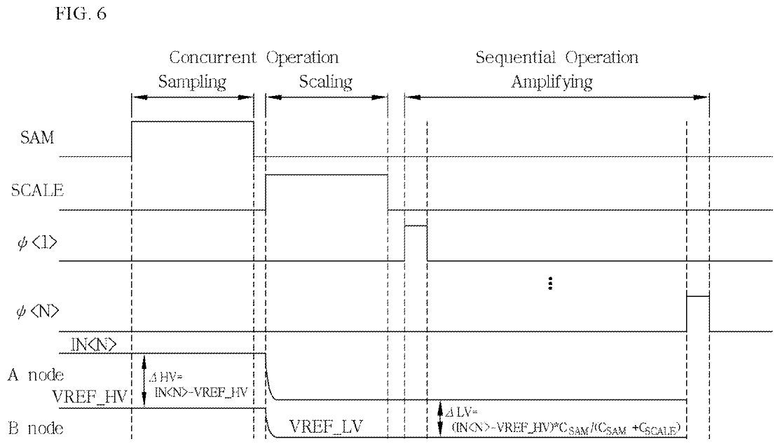

FIG. 6 is a timing diagram of the sensing circuit according to another embodiment.

Referring to FIGS. 5 and 6, the sampling circuit 20 may simultaneously sample the plurality of input signals IN<1> to IN<N>, received through the multiple channels, in response to the sampling signals SAM.

In other words, the sampling circuit 20 may sample the plurality of input signals IN<1> to IN<N> at the same first time.

At this time, the sampling circuit 20 may sample a difference ΔHV between the plurality of input signals IN<1> to IN<N> and the first reference voltage VREF_HV.

Next, the sampling circuit 20 may simultaneously scale the plurality of sampling signals in response to the scaling signals SCALE.

In other words, after sampling the difference ΔHV, the sampling circuit 20 may scale the plurality of sampling signals at the same second time.

In this case, the sampling circuit 20 may scale the plurality of sampling signals into lower voltages than the plurality of sampling signals.

The sampling circuit 20 may sample a difference ΔLV between the plurality of sampling signals and the second reference voltage VREF_LV.

In this case, the voltage range of the scaling signals may be changed by adjusting the capacities of the sampling capacitor C_{SAM} and the scaling capacitor C_{SCALE}.

Next, the sampling circuit 20 may sequentially output, to the amplifier circuit 30, the plurality of scaling signals one by one at given time intervals in response to the control signals Φ<1> to Φ<N>.

Next, the amplifier circuit 30 may sequentially amplify the scaling signals sequentially output from the sampling circuit 20.

As described above, the sensing circuit and the source driver according to an embodiment can accurately sense mobility characteristics of pixels by simultaneously sampling and simultaneously scaling input signals from multiple channels.

Furthermore, embodiments can accurately sense mobility characteristics of pixels regardless of an increase in the number of multiple channels.

Furthermore, embodiments may enable picture quality to be compensated for by accurately sensing mobility characteristics of pixels.

Furthermore, embodiments do not need to use a separate protection circuit between a high-voltage circuit and a low-voltage circuit because amplification and analog-to-digital conversion are performed after a high-voltage input signal is sampled and scaled into a low voltage.

As described above, embodiments can accurately sense mobility characteristics of pixels by simultaneously sampling and simultaneously scaling input signals from multiple channels.

Furthermore, embodiments can accurately sense mobility characteristics of pixels regardless of an increase in the number of multiple channels.

Furthermore, embodiments may enable picture quality to be compensated for by accurately sensing mobility characteristics of pixels.

Furthermore, embodiments does not need to use a separate protection circuit between a high-voltage circuit and a low-voltage circuit because amplification and analog-to-digital conversion are performed after a high-voltage input signal is sampled and scaled into a low voltage.

While various embodiments have been described above, it will be understood to those skilled in the art that the embodiments described are by way of example only. Accordingly, the disclosure described herein should not be limited based on the described embodiments.

What is claimed is:

1. A sensing circuit comprising:
multiple channels configured to receive a plurality of input signals from a display panel; and
a sampling circuit configured to sample the plurality of input signals received through the multiple channels and scale a plurality of sampling signals,
wherein the sampling circuit samples the plurality of input signals at a same first time and scales the plurality of sampling signals at a same second time.

2. The sensing circuit of claim 1, wherein the sampling circuit scales the plurality of sampling signals into lower voltages than the plurality of sampling signals.

3. The sensing circuit of claim 2, wherein the sampling circuit sequentially outputs scaling signals corresponding to the multiple channels, respectively.

4. The sensing circuit of claim 3, further comprising an amplifier circuit configured to amplify the scaling signals corresponding to the multiple channels, respectively, and output the output signals to an analog-to-digital converter (ADC).

5. The sensing circuit of claim 1, wherein the sampling circuit comprises:
a first switch circuit configured to transmit the plurality of input signals and a first reference voltage;
a first capacitor circuit configured to sample a difference between the plurality of input signals and the first reference voltage;
a second switch circuit configured to transmit the plurality of sampling signals sampled by the first capacitor circuit and a second reference voltage;
a second capacitor circuit configured to sample a difference between the plurality of sampling signals and the second reference voltage; and
a third switch circuit configured to sequentially transmit the plurality of scaling signals sampled by the second capacitor circuit,
wherein the second reference voltage is set to be lower than the first reference voltage.

6. The sensing circuit of claim 5, wherein the first switch circuit transmits the plurality of input signals and the first reference voltage to the first capacitor circuit at the same first time.

7. The sensing circuit of claim 5, wherein:
the first capacitor circuit comprises sampling capacitors corresponding to the multiple channels, respectively,
the second capacitor circuit comprises scaling capacitors corresponding to the multiple channels, respectively, and
a voltage range of the plurality of scaling signals is changed by adjusting capacities of the sampling capacitor and the scaling capacitor.

8. The sensing circuit of claim 5, wherein the second switch circuit transmits the plurality of sampling signals and the second reference voltage to the second capacitor circuit at the same second time.

9. The sensing circuit of claim 5, wherein the third switch circuit sequentially transmits the plurality of scaling signals to an amplifier circuit at given time intervals.

10. The sensing circuit of claim 9, wherein:
the amplifier circuit sequentially amplifies the plurality of scaling signals and outputs output signals to an analog-to-digital converter (ADC), and
the second reference voltage varies depending on an input voltage range of the ADC.

11. A source driver comprising:
a sensing circuit comprising multiple channels configured to receive a plurality of input signals from a display panel and a sampling circuit configured to sample the plurality of input signals received through the multiple channels and to scale a plurality of sampling signals; and
an analog-to-digital converter (ADC) configured to convert output signals of the sensing circuit into digital data,
wherein the sensing circuit samples the plurality of input signals at a same first time and scales the plurality of sampling signals at a same second time.

12. The source driver of claim 11, wherein the sensing circuit scales the plurality of sampling signals into lower voltages than the plurality of sampling signals.

13. The source driver of claim 12, wherein the sensing circuit sequentially amplifies the scaling signals corresponding to the multiple channels, respectively, and outputs the output signals to the ADC.

14. The source driver of claim 11, wherein the sampling circuit comprises:
a first switch circuit configured to transmit the plurality of input signals and a first reference voltage;
a first capacitor circuit configured to sample a difference between the plurality of input signals and the first reference voltage;
a second switch circuit configured to transmit the plurality of sampling signals sampled by the first capacitor circuit and a second reference voltage;
a second capacitor circuit configured to sample a difference between the plurality of sampling signals and the second reference voltage; and
a third switch circuit configured to sequentially transmit the plurality of scaling signals sampled by the second capacitor circuit,
wherein the second reference voltage is set to be lower than the first reference voltage.

15. The source driver of claim 14, wherein:
the first capacitor circuit comprises sampling capacitors corresponding to the multiple channels, respectively,
the second capacitor circuit comprises scaling capacitors corresponding to the multiple channels, respectively, and
a voltage range of the plurality of scaling signals is changed by adjusting capacities of the sampling capacitor and the scaling capacitor.

16. The source driver of claim 14, wherein the second reference voltage varies depending on an input voltage range of the ADC.
